(19) United States
(12) Patent Application Publication
(10) Pub. No.: US 2014/0057720 A1
(43) Pub. Date: Feb. 27, 2014

(54) System and Method for Capture and Use of Player Vital Signs in Gameplay

(71) Applicant: 2343127 Ontario Inc., Toronto (CA)

(72) Inventors: Yousuf Chowdhary, Maple (CA); Jeffrey Brunet, Aurora (CA); Ravinder ("Ray") Sharma, Toronto (CA)

(73) Assignee: 2343127 Ontario Inc., Toronto (CA)

(21) Appl. No.: 13/973,115

(22) Filed: Aug. 22, 2013

Related U.S. Application Data
(60) Provisional application No. 61/742,888, filed on Aug. 22, 2012.

(51) Int. Cl. A63F 13/00

(52) U.S. Cl. CPC A63F 13/00
USPC 463/36

(57) ABSTRACT

A computer-implemented method is provided for enabling virtual gameplay with a virtual character on a computing device. The player can access at least one video game and interact with the video game via a virtual character. The computing device detects or receives and stores at least one vital sign of the player. This vital sign is used to retrieve a storyline for the virtual character to interact with, which is related to the at least one vital sign.

### CROSS-REFERENCE TO RELATED APPLICATIONS

This application claims the benefit of U.S. Provisional Patent Application No. 61/742,888, filed Aug. 22, 2012 and entitled “System and Method for Capture and Use of Player Vital Signs in Gameplay,” which is incorporated herein by reference in its entirety.

### FIELD OF INVENTION

The present invention is related to capturing the player vital signs and using this information to impact the gameplay of virtual worlds.

### BACKGROUND

A virtual world is a computer simulated environment. A virtual world may resemble the real world, with real world rules such as physical rules of gravity, geography, topography, and locomotion. A virtual world may also incorporate rules for social and economic interactions between virtual characters. Players (users) may be represented as avatars, two or three-dimensional graphical representations. Virtual worlds may be used for massively multiple online role-playing games, for social or business networking, or for participation in imaginary social universes.

Prior art virtual worlds have storylines that are either static or branch in a rather predictable fashion. Prior art methods for a branching storyline are well known in the industry, where the outcome of one encounter defines the starting point of the next. Such virtual worlds have a set number of possible branches and a player's skills, interaction with other players and non-player characters (NPCs) aid in the creation of variety and new possibilities. Mostly the storyline is also dependent on the virtual character (Player Character) that a player chooses to engage in the gameplay of the virtual world.

Above described prior art lack the ability to take the player's vital signs into account for meaningful impact on the gameplay. Our invention overcomes these limitations of the prior art and provides methods and systems that offer a richer and more unique gameplay experience for each player.

### SUMMARY

This application describes a system and method to capture player vital signs and using that information to impact the gameplay of a virtual world.

A player's vital signs e.g. heart rate, skin temperature, blood pressure, breathing rate, pain, emotional distress, perspiration, body odour, etc. can reveal a significant amount of information about the player as the player engages in gameplay of a virtual world. By determining the vital signs of a player engaged in the gameplay of a virtual world and impacting the storyline of a virtual world based on this information a more interesting and meaningful experience can be provided. Thus a player may be willing to spend more time engaging with a virtual world when the said virtual world's storyline is impacted by the player's vital signs.

This application describes systems and methods whereby the storyline of a virtual world may change based on the real world vital signs of a player. Thus real vital signs of a player can influence the gameplay of a virtual world.

In one embodiment of the invention, the level of difficulty of the gameplay may be increased or decreased (or the gameplay otherwise altered) depending on the captured player vital signs. For example, if the player's heart rate is too low, the gameplay may be changed to make it harder, while if a player is exhibiting a high breathing rate the gameplay may be changed to make it easier to play the game.

The system uses available sensors to capture the player vital signs while playing a game. For example the method may use any one or any combination of different sensors to gather the player vital signs; e.g. using a smart phone application to measure not only heart rate, but also heart rhythm, respiration rate and blood oxygen saturation using the phone's built-in video camera.

Some existing device sensors can be used to provide information that can be deciphered to reveal the player's vital signs. For example, an embedded video capture sensor (camera) can provide visual information that can be used for measuring the blood flow and the heart rhythm. Such devices may include but not limited to an iPhone, iPad, Smartphones, Android phones, personal computers e.g. laptops, tablet computers, touchscreen computers, gaming consoles and online server based games.

In another embodiment, specific embedded sensors purpose designed for gathering the vital signs of a player may be utilized. Thus purpose-built gamepads with temperature sensors and heart-rate monitors may be used such that these sensors are positioned advantageously in areas where a player's hands or other body parts may come in contact with the gamepad as the player engages in the gameplay of a virtual world.

The term “storyline” may include but is not limited to the aesthetics, virtual characters that are available, plot, set of plot nodes, settings etc. and may change individually or in combination with the vital signs of the player.

The storyline can change, evolve, branch or morph based on the vital signs of the player. Alternate settings may be applied, alternate levels may be offered for gameplay based on the vital signs of a player. In one embodiment of the invention, the items and loot that the players may come across, monsters and enemies that they may fight, traps and puzzles that they may have to overcome may vary based on a player's vital signs.

According to a first aspect of the invention, a computer-implemented method is provided for enabling virtual gameplay with a virtual character on a computing device. The computing device is in communication with a storage means. Access is provided to at least one video game in which a player is able to interact with the video game via a virtual character. At least one vital sign of the player is detected or received at the computing device, and this is stored on the storage means. In response to the detected at least one vital sign, the computing device retrieves a storyline for the virtual character to interact with. The retrieved storyline is related to the at least one vital sign of the player.

A second or subsequent vital sign of the player may also be detected in the course of gameplay, and a second or further storyline retrieved for the player's virtual character to interact with. This second or further storyline is related to the second or subsequent vital sign.

Preferably, each storyline comprises one or a combination of plot, plot nodes, character interactions, encounters, settings, aesthetics, levels, premise, or theme.

The second or further storyline may replace the previously retrieved storyline, or it may be added to the previously retrieved storyline.

Various aspects of the game or virtual world may be changed in response to the detected at least one vital sign. Examples include:
the virtual character's appearance, facial or body expression or health;
level of difficulty (e.g. detected resting or calm vital sign may result in an increased level of difficulty, while an agitated or elevated vial sign may result in a decreased level of difficulty);
the scene or setting;
game monsters, enemies, traps or puzzles;
character statistics of the virtual character; and
tools, weapons, equipment or clothing of the virtual character.

In one embodiment, a relative range of vital sign is considered with respect to an operating context within the game.

In some instances, the virtual character's appearance or conduct may be changed in response to the player's detected vital sign(s). The virtual character may be changed to reflect a state matching the player's detected vital sign (e.g. out of breath, fatigued, frustrated, or excited). Alternatively, the virtual character may be changed to reflect a state opposite to the player's detected vital sign (e.g. the more the player gets excited or agitated, the calmer or more relaxed the virtual character appears).

In one embodiment, the video game is accessible by multiple players, each player having a detected vital sign. In this embodiment, players within a similar range in their detected vital signs may be allowed to interact in the game with each other via their virtual characters. The multi-player game may be set up so that a new player joining the game having a previously-unrepresented range of vital sign opens up a new storyline for all of the players currently in the game. Further, if a player is the only player within a specific range of vital sign, the departure of that player from the game may close up the storyline for the remaining players in the game.

The at least one vital sign may be re-detected at intervals. In the event of a change in the vital sign, the virtual character may be shown moving to a new scene in the storyline.

A baseline reading of the player's vital sign may first be detected before the game. A subsequently detected vital sign may thereafter be compared to see if it is above or below the baseline.

The player's vital sign may also be compared to a database of normal ranges for that vital sign. The database may be broken down by at least one of: gender, sex, age, height, weight, build, physical condition. The database may be further broken down having regard to aspects of the game operating context.

The database may be customized with player input.

If a null vital sign is detected or if the detected vital sign is unsupported, a default storyline may be provided.

The storage means may be provided by one or a combination of: a local fixed memory, a local removable memory, a remote fixed memory, a remote removable memory, and a virtual memory. The storage means may be selected from the group consisting of: a local data storage of a game console, a local inbuilt memory, a user provided memory, an online server, and a shared folder on a network.

Vital sign data may be retrieved from a sensor. The player may be enabled to play the game using a game device. An on-board sensor on the game device may be used to detect the player's at least one vital sign. In one embodiment, the game device may be a mobile device. For example, the sensor may be one or a combination of: camera, video camera, microphone, accelerometer, gyroscope, touch screen, temperature sensor, pressure sensor, heart rate monitor, pulse monitor, respiration monitor, moisture sensor, pH sensor, artificial nose. In one embodiment, the sensor is a purpose-built sensor. In one embodiment, the sensor is attached to the player's body during gameplay.

Vital sign information may also (or in the alternative) be obtained from player input.

The sensor may be a sensor that is not otherwise used as a game controller. Sensors used as a game controller are preferably not also (or at the same time) used to receive player vital signs.

In one embodiment, the onboard sensor is a video camera. The video camera may be used to detect blood flow, blood colour, or blood pressure as a vital sign.

### BRIEF DESCRIPTION OF THE FIGURES

FIG. 1 is a flow diagram illustrating the primary steps of the method, according to a preferred embodiment.

FIG. 2 is a flow diagram representing an example of sensor detection of player vital signs and mapping to known vital signs in a database.

FIG. 3 is a conceptual diagram illustrating the interplay between multiple sensors and aspects of the storyline in a virtual world.

FIG. 4 is a flow diagram representing an example of ongoing vital sign detection.

FIG. 5 is a flow diagram representing an example of how vital signs may be used in a MMORPG context to open certain plot nodes.

FIG. 6 is a flow diagram representing an example of how vital signs may be used in a MMORPG context to close certain plot nodes.

FIG. 7 is a conceptual diagram of a simple embodiment of the invention, in this case using a heart rate sensor/monitor in communication with a mobile device to detect player heart rates and thereby impact the gameplay.

FIG. 8 is an example block diagram of a mobile device showing exemplary sensors.

### DETAILED DESCRIPTION

Methods and arrangements are provided for capturing player vital signs and using these to impact the virtual worlds or their gameplay.

Before embodiments of the invention are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A “virtual world” as used herein need not be a “game” in the traditional sense of a competition in which a winner and/or loser is determined, but rather that the term “game” incorporates the idea of a virtual world. Moreover, a person or entity who enters the virtual world in order to conduct business, tour the virtual world, or simply interact with others or the virtual environment, with or without competing against another person or entity is still considered to be “playing a game” or engaging in the gameplay of the game.

Virtual worlds can exist on game consoles for example Microsoft Xbox, and Sony Playstation, Nintendo Wii, etc., or on online servers, or on mobile devices (e.g. an iPhone or an iPad), Smartphones, portable game consoles like the Nintendo 3DS, or on a PC (personal computer) running MS Windows, or MacOS, Linux, Google Android or another operating system. This list is not exhaustive but is exemplary of devices or computing environments where virtual worlds can exist, many other variations are available and known to the ones skilled in the art.

A computer or a game console that enables a user to engage with a virtual world, including a memory for storing a control program and data, and a processor (CPU) for executing the control program and for managing the data, which includes user data resident in the memory including a set of gameplay statistics. The computer, or a game console, may be coupled to a video display such as a television, monitor, or other type of visual display while other devices may have it incorporated in them (iPad). A game or other simulations may be stored on a storage media such as a DVD, a CD, flash memory, USB memory or other type of memory media. The storage media can be inserted to the console where it is read. The console can then read program instructions stored on the storage media and present a game interface to the user.

The term “player” is intended to describe any entity that accesses the virtual world, regardless of whether or not the player intends to or is capable of competing against other players. Typically, a player will register an account with the game console within a peer-to-peer game and may choose from a list or create virtual characters that can interact with other virtual characters of the virtual world.

The term “engage in gameplay” generally implies playing a game whether it is for the purpose of competing, beating, or engaging with other players. It also means to enter a virtual world in order to conduct business, tour a virtual world, or simply interact with others or a virtual environment, with or without competing against another entity.

Typically, a user or a player manipulates a game controller to generate commands to control and interact with the virtual world. The game controller may include conventional controls, for example, control input devices such as joysticks, buttons and the like. Using the controller a player can interact with the game, such as by using buttons, joysticks, and movements of the controller and the like. This interaction or command may be detected and captured in the game console. The player's inputs can be saved, along with the game data to record the game play.

Another method to interact with a virtual world is using the touch screen for interaction with the virtual world. A gesture refers to a motion used to interact with multipoint touch screen interfaces. Multi-touch devices employ gestures to perform various actions. Thus some sensor may be embedded in the touchscreen so that as the player engages in the normal gameplay of a virtual world, his/her vital signs are automatically captured.

A virtual object may comprise any one of a virtual character of an online game, a virtual good of an online game, a weapon of an online game, a vehicle of an online game, virtual currency of an online game, experience points of an online game and permissions of an online game etc. A virtual object may further be any item that exists only in a virtual world (game).

A virtual object may include virtual money, experience points, weapons, vehicles, credentials, permissions and virtual gold. A player's online persona may obtain these virtual objects via gameplay, purchase or other mechanisms. For example, as a player of a first person shooter completes various levels of the game, he obtains additional weapons, armour, outfits, experience points and permissions. Additional weapons and armour which may be beneficial in facilitating the completion of levels and allow the player to perform in new and different ways may be acquired (i.e. purchased). Additional permissions may unlock additional levels of the game or provide access to an otherwise hidden forum or stage. Whatever the items, players are constantly in search of virtual objects so as to enrich their game experience.

A virtual object may be defined by its function and form. The functional component of a virtual object describes its functional properties such as whether it is a weapon, whether it can be worn, where it can be worn, how heavy it is, and what special powers it has. In contrast, the form component of a virtual object describes the look, feel, and sound that are its characteristics. Virtual object can have some function within their virtual world, or can be solely used for aesthetic purposes, or can be both functional and decorative. The virtual character can be considered a special kind of a virtual object; it has a function, as well as a form and it represents a player and may also be controlled by the player.

Virtual character may include a persona created by a player or chosen from a list in the virtual world. Typically virtual characters are modeled after humans whether living or fantasy (e.g. characters from mythology).

A virtual character (can be considered a special virtual object) is represented by one or more gameplay statistics, which encapsulate some meaning to connect the virtual (and digital) reality of the game to the real world. Many of these statistics are not apparent to the player as such, but are instead encoded within the framework of the game or composed together to form a script. In role-playing games (RPGs) and similar games, these statistics may be explicitly exposed to the player through a special interface, often with added meaning which provides context for the player's actions.

A statistic (stat) in role-playing games (RPG) is a datum which represents a particular aspect of a virtual character. Most virtual worlds separate statistics into several categories. The set of categories actually used in a game system, as well as the precise statistics within each category may vary greatly from one virtual world to another. Many virtual worlds also use derived statistics whose values depend on other statistics, which are known as primary or basic statistics. Derived statistics often represent a single capability of the character such as the weight a character can lift, or the speed at which they can move. Derived statistics are often used during combat, can be unitless numbers, or may use real-world units of measurement such as kilograms or meters per second.

A virtual character's statistics affects how it behaves in a virtual world. For example, a well-built muscular virtual character may be more powerful and be able to throw certain virtual objects farther, but at the same time may lack dexterity when maneuvering intricate virtual objects. A virtual character may have any combination of statistics, but these statistics may be limited by either hard counters, soft counters or a combination of both.

Primary Statistics represent assigned, abstract qualities of a virtual character, such as Strength, Intelligence, and so on. Partially defined by convention and partially defined by context, the value of a primary statistic corresponds to a few direct in-game advantages or disadvantages, although a higher statistic is usually better. In this sense, primary statistics can only really be used for direct comparison or when determining indirect advantages and disadvantages.

Derived Statistics represent measured, concrete qualities of a virtual character, such as maximum carry weight, perceptiveness, or skill with a weapon. Such a stat is derived from some function of one or more of a character's primary stats, usually addition or multiplication. These stats then serve an important function in turn, providing a fair means by which to arbitrate conflicts between virtual characters and the virtual environment. For example, when two virtual characters are in violent conflict, Strength, a primary statistic, might be used to calculate damage, a derived statistic, with the winner being the character that inflicts the most damage on the other.

For the purpose of this application the term “gameplay statistics” refers to any one or any combination of gameplay frequency, gameplay time, number of times game played, percent game complete etc. as result of engaging in gameplay.

An avatar may include the physical embodiment of a virtual character in the virtual world.

In virtual worlds (video/computer games) a non-player character (NPC) is a virtual character that is controlled by the program and not a player. NPC may also refer to other entities not under the direct control of players. NPC behaviour in a virtual world may be scripted and automatic.

A player character or playable character (PC) is a virtual character in a virtual world that is controlled or controllable by a player. A player character is a persona of the player who controls it. In some cases a virtual world has only one player character and in other cases there may be a small number of player characters from which a player may pick a certain virtual character that may suit his or her style of gameplay, while in other scenarios there may be a large number of customizable player characters available from which a player may choose a virtual character of their liking. An avatar—may include the physical embodiment of a virtual character in the virtual world.

Virtual objects in a virtual world interact with the player, the virtual environment, and each other. This interaction is generally governed by a physics engine which enables realism in modeling physical rules of the real world (or arbitrary fantasy worlds). A physics engine is a computer program that, using variables such as mass, force, velocity, friction and wind resistance may simulate and predict effects under different conditions that would approximate what happens in either the real world or a fantasy world. A physics engine can be used by other software programs for example games or animation software to enhance the way virtual objects imitate the real world to produce games and animations that are highly realistic or to create dream-world effects.

Health is a game mechanic used in virtual worlds to give a value to virtual characters, enemies, NPCs, (non player characters) and related virtual objects. Health is often abbreviated by HP which may stand for health points or hit points; it is also synonymous with damage points or heart points. In virtual worlds health is a finite value that can either be numerical, semi-numerical as in hit/health points, or arbitrary as in a life bar, and is used to determine how much damage (usually in terms of physical injury) a virtual character can withstand when said virtual character is attacked, or sustains a fall. The total damage dealt (which is also represented by a point value) is subtracted from the virtual character's current HP. Once the virtual character's HP reaches 0 (zero), the virtual character is usually unable to continue to fight or carry forward the virtual world's mission.

A typical life bar is a horizontal rectangle which may begin full of colour. As the virtual character is attacked and sustains damage or mistakes are made, health is reduced and the coloured area gradually reduces or changes colour, typically from green to red. At some point the life bar changes colour completely or loses colour, at this point the virtual character is usually considered dead.

At the start of a typical game, the virtual character may have 10 health and be surrounded by numerous enemies. Each enemy applies an attack influence (a force toward the enemy) and a flee influence (a force away from the enemy) to the virtual character. Given these circumstances, the attack influence would carry the strongest priority, and so we would expect the virtual character to move toward the closest enemy (since influence is inversely proportional to distance).

Mobile devices including connected and unconnected devices are becoming the primary devices for playing games and keeping in touch. Such devices tend to be small, have limited but growing processing and storage capacity and are usually powered by a re-chargeable battery. Although the main examples used in this application use a mobile device as an example, it is clear that the invention can also be used with significant advantages on other computing devices e.g. a computer that may be connected to one or more sensors, a gaming console with gamepads that incorporate sensors, online gaming servers connected with computers or gamepad with sensors etc.

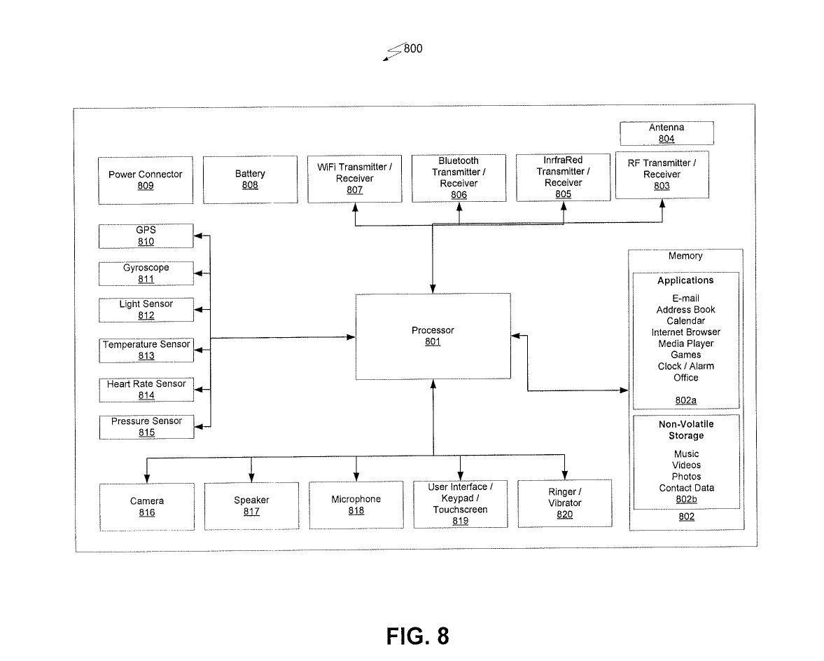

Before turning to a discussion of the method of the present invention, a brief orientation of one embodiment of the technological infrastructure is in order. FIG. 8 depicts an exemplary block diagram of a mobile device 800. Exemplary electronic circuitry of a typical mobile phone are shown; other devices may differ and may either omit or have electronic components not shown here. The mobile device 800 includes one or more microprocessors 801, which is electronically coupled to other electronic components such as memory 802 (e.g., non-volatile memory such as ROM and volatile memory such as RAM) which stores processor-readable code which is executed by one or more processors of the control processor 801 to implement the functionality described herein.

Mobile device 800 may include, for example, processors 801, memory 802 including applications 802a and non-volatile storage 802b. The processor 801 can implement communications, as well any number of applications, including the virtual world and gaming applications discussed herein. Memory 802 can be any variety of memory storage media types, including non-volatile and volatile memory. A device operating system handles the different operations of the mobile device 800 and may contain user interfaces for operations, such as placing and receiving phone calls, text messaging, multi-media messaging, checking voicemail, e-mail, games and the like. Applications 802a can be any assortment of programs. Examples include a camera application for photos and/or videos, an address book, a calendar application, a media player, an internet browser, games, an alarm application, other third party applications, and the gaming applications discussed herein. The non-volatile storage component 802b in memory 802 contains data such as web caches, music, photos, contact data, scheduling data, and may contain game data/statistics, and other files.

The processor 801 also communicates with RF transmitter/receiver circuitry 803 which in turn is coupled to an antenna 804, with an infrared transmitter/receiver 805, with a Bluetooth transmitter/receiver 806, a WiFi transmitter/receiver 807, a battery 808, a power connector 809, a GPS 810, a gyroscope 811, a light sensor 812, a temperature sensor 813, a heart rate sensor 814, a pressure sensor 815, a camera 816, a speaker 817, a microphone 818, a user interface/keyboard or a touchscreen 819, and a ringer/vibrator 820. It will be appreciated that some or all of these components may be onboard or auxiliary. In particular, the sensors 810-815 may be separate physical components that are in wired or wireless communication with the mobile device 800.

The processor 801 also communicates with Infrared transmitter/receiver circuitry 805. The infrared transmit component flashes an infrared light in a particular pattern, which another component (the infrared receiver) can pick up and translate into an instruction. These transmitters and receivers are also typically found in remote controls and are now embedded in mobile devices that can turn them into remote control devices. They typically generate infrared using light emitting diodes (LEDs), and the main component of a receiver unit is usually a photodiode.

The processor 801 also communicates with Bluetooth transmitter/receiver circuitry 806. Bluetooth is a standard wire-replacement communications protocol primarily designed for low power consumption, with a short range. Bluetooth provides a secure way to connect and exchange information between devices such as mobile phones, laptops, personal computers etc. A Bluetooth-enabled mobile device is able to pair with many other devices for communications.

The processor 801 also communicates with WiFi transmitter/receiver circuitry 807. WiFi is a technology that allows an electronic device to exchange data or connect to the internet wirelessly using radio frequencies. Thus the embedded WiFi transmitter/receiver circuitry 807 in a mobile device allow it to connect to the internet for communications. A WiFi-enabled mobile device can connect to the Internet when within range of a wireless network which is configured to permit this.

A battery 808 provides a power source to operate the different electronic components in the mobile device 800. An electric battery is a device consisting of one or more electrochemical cells that convert stored chemical energy into electrical energy. Typically the battery 808 is a rechargeable battery.

The processor 801 controls transmission and reception of wireless signals. During a transmission mode, the processor 801 provides a voice signal from microphone 818, or other data signal, to the RF transmitter/receiver circuitry 803. The RF transmitter/receiver circuitry 803 transmits the signal to a remote station (e.g., a fixed station, operator, other cellular phones, etc.) for communication through the antenna 804. The ringer/vibrator 820 is used to signal an incoming call, text message, calendar reminder, alarm clock reminder, or other notification to the user. During a receiving mode, the RF transmitter/receiver circuitry 803 receives a voice or other data signal from a remote station through the antenna 804. A received voice signal is provided to the speaker 817 while other received data signals are also processed appropriately.

A physical power connector 809 can be used to connect the mobile device 800 to an external power source, such as an AC adapter or powered docking station. In some cases the same physical connector as the power connector 809 can also be used as a data connection to a computing device (e.g. on an iPhone). The data connection allows for operations such as synchronizing mobile device data with the computing data on another device.

A global positioning service (GPS) receiver 810 utilizing satellite-based radio navigation to relay the position of the user applications enabled for such service.

A gyroscope 811, is a device for measuring or maintaining orientation, based on the principles of angular momentum and allows for more accurate recognition of movement within a 3D space. Gyroscopes in consumer electronics are frequently combined with accelerometers (acceleration sensors) for more robust direction- and motion-sensing.

A light sensor 812, is a device for sensing light and may be used for automatically adjusting the brightness of the screen back-light both to improve battery life and make it easier to see the screen.

A temperature sensor 813, is a device for sensing and measuring temperature.

A heart rate sensor 814, is a device for sensing and measuring the heart rate.

A pressure sensor 815, is a device for sensing and measuring the pressure.

A camera 816, is a device for capturing video images (still and motion). Cameras embedded in mobile devices like mobile phones can capture and share pictures almost instantly and automatically. This enables services like multi-media messaging, video calling, and the like. The cameras embedded in mobile devices like smartphones may also be used as input devices in numerous applications, e.g. reading QR codes; where the QR codes can be sensed by the mobile device using its camera and provide a link to related digital content, via a URL.

A speaker 817, is a device that converts electrical signals into sound. A speaker on a mobile device is used for communications that is relaying the sound of the remote party as RF signals received via the antenna 804, coupled to the RF transmitter/receiver 803 and processed by the processor 801. A speaker may also be used for playing the audio e.g. music that may be stored on the mobile device or may be streaming using internet communications.

A microphone 818, is a device that converts sound signals into electrical signals. A microphone on a mobile device is used for communications by converting the sound of the user to the remote party. Sound signals converted to electrical signals are relayed to the remote party as RF signals received via the antenna 804, coupled to the RF transmitter/receiver 803 and processed by the processor 801.

A user interface/keyboard or a touchscreen 819, are among the many different methods for receiving input from a user and converting this input into the appropriate electrical signals to be processed by the processor 801. Most smartphones these days have a touchscreen that enables a user to touch and provide an input e.g. typing text, or playing a game using gestures.

A ringer/vibrator 820 is used for alerting a user of any incoming or outgoing communications, e.g. an incoming call, an outgoing e-mail.

Although mobile devices are described as one preferred embodiment, it will be appreciated that the methods are equally applicable to other devices, platforms and communication structures.

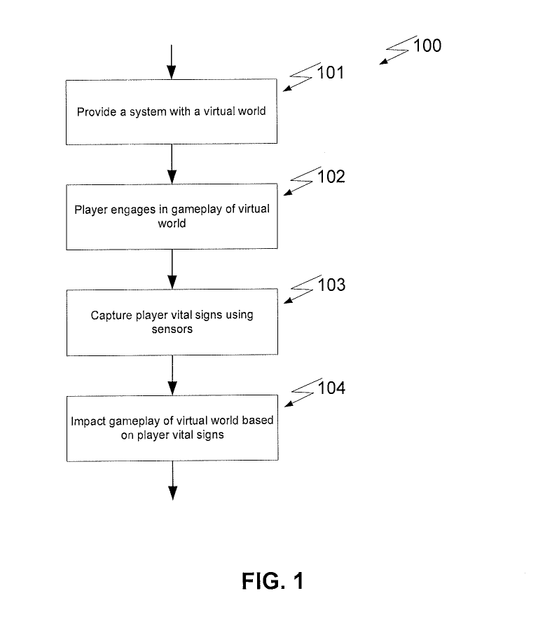

Turning now to the method, FIG. 1 is a flow diagram illustrating the primary steps of the method according to one embodiment.

A system is provided with a virtual world 101. The virtual world may be a single player game or a multiplayer game or a MMORPG (Massively Multiplayer Online Role Playing Game) and may exist on any type of a gaming device which may include but not limited to an iPhone, iPad, Smartphones, Android phones, personal computers e.g. laptops, gaming consoles like Nintendo Wii, Nintendo DS, Sony PlayStation, Microsoft Xbox 360, and online server based games etc.

The computer program may comprise: a computer usable medium having computer usable program code, the computer usable program code comprises: computer usable program code for enabling change in storyline based on the vital signs of a player, computer usable program code for presenting graphically to the player the different options available to modify and personalize different aspects of the virtual world including but not limited to settings.

The player engages in gameplay of the virtual world 102. As mentioned earlier, the term “engage in gameplay” generally implies playing a game whether it is for the purpose of competing, beating, or engaging with other players. It also means to enter a virtual world in order to conduct business, tour a virtual world, or simply interact with others or a virtual environment, with or without competing against another entity.

A virtual world that incorporates the invention, either in its entirety or some components of it, may be a single player game or a multiplayer game or a MMORPG (Massively Multiplayer Online Role Playing Game) and may exist on any type of a gaming device which provides a either a video capture sensor (camera) and sensors like accelerometer and gyroscope built in it, and may include but not limited to an iPhone, iPad, Smartphones, Android phones, personal computers e.g. laptops, tablet computers, touchscreen computers, gaming consoles and online server based games.

Vital signs of the player are captured using output from the sensors 103. Vital signs are measures of various physiological statistics in order to assess the most basic body functions. There are four vital signs which are standard in most medical settings; temperature, blood pressure, pulse and respiratory rate. These signs may be watched, measured, and monitored to check an individual's level of physical functioning. Normal vital signs change with age, sex, weight, exercise tolerance, and condition. Normal vital sign ranges for the average healthy adult while resting are:

Blood pressure: 90/60 mm/Hg to 120/80 mm/Hg

Breathing: 12-18 breaths per minute

Pulse: 60-100 beats per minute

Temperature: 97.8-99.1 degrees Fahrenheit/average 98.6 degrees Fahrenheit

Temperature

Temperature can be recorded in order to establish a baseline for the individual's normal temperature for the site and measuring conditions. The normal body temperature of an individual is a measure of the core body temperature that varies according to the gender, weight, recent activity, food and fluid consumption and time of the day.

Blood Pressure

Blood pressure is the force with which the blood pushes against the artery walls, each time the heart beats. While measuring blood pressure, two pressures are recorded: systolic pressure and diastolic pressure. Systolic blood pressure refers to the pressure inside the artery when the heart contracts and pumps blood into the body. Whereas diastolic blood pressure refers to the pressure inside the artery in between the heartbeats, i.e., when the heart is at rest. Both these blood pressures are measured in “mm Hg” (millimeters of mercury). The blood pressure is recorded as two readings; a high systolic pressure, which is the maximal contraction of the heart, and the lower diastolic or resting pressure. A normal blood pressure would be 120 being the systolic over 80, the diastolic. Usually the blood pressure is read from the left arm. The difference between the systolic and diastolic pressure is called the pulse pressure. The measurement of these pressures is now usually done with an aneroid or electronic sphygmomanometer.

Pulse

The pulse is the physical expansion of the artery. Its rate is usually measured either at the wrist or the ankle and is recorded as beats per minute. The pulse rate is the measure of an individual's heart rate or number of times a heart beats per minute. It varies or fluctuates with exercise, illness, injury, and emotions. The heart pumps blood through the arteries, which expand and contract with the flow of the blood and so, the pulse rate can be measured on any surface artery that runs over a bone. However, one of the most commonly used place to measure pulse rate is the radial artery in the wrist. The pulse commonly taken is from the radial artery at the wrist. The pulse rate can also be measured by listening directly to the heartbeat using a stethoscope. The pulse varies with age. A newborn or infant can have a heart rate of about 130-150 beats per minute. A toddler's heart will beat about 100-120 times per minute, an older child's heartbeat is around 60-100 beats per minute, adolescents around 80-100 beats per minute, and adults' pulse rate is anywhere between 50 and 80 beats per minute.

Respiratory Rate

Varies with age, but the normal reference range for an adult is 12-20 breaths/minute. The respiratory rate is basically the number of breaths an individual takes per minute. It is normally measured by counting the number of times a person breathes in a minute when at rest. However, the respiratory rate varies with excitement level, fever, illness or any other health conditions.

Other vital signs may include but are not limited to the following:

Pain

Emotional Distress

Perspiration

Body Odour

As technology advances, more and more miniaturized electronic components become cost effective to be mass produced and included in all sorts of devices. Today many types of mobile devices e.g. Smartphones like iPhone include built-in cameras (front facing as well as rear facing), microphones, accelerometers, gyroscopes, and GPS sensors. Such devices also have data coverage via mobile cellular network or WiFi, and are widely used for engaging in the gameplay of virtual worlds. Thus determining the player vital signs with some accuracy using one or more of the embedded sensors has become possible.

Sensors

Micro-Electro-Mechanical Systems (MEMS) is the integration of mechanical elements, sensors, actuators, and electronics on a common silicon substrate through microfabrication technology. In essence MEMS are tiny mechanical devices that are built onto semiconductor chips and are measured in micrometers. While the electronics are fabricated using integrated circuit process sequences the micromechanical components are fabricated using compatible “micromachining” processes. Complete systems-on-a-chip MEMS are an enabling technology allowing the development of smart products, augmenting the computational ability of microelectronics with the perception and control capabilities of microsensors and microactuators. Various sensors available on mobile devices are briefly discussed below.

Video Capture Device (Camera)

A video capture device e.g. a camera can be used to capture the video or still image of the player and using the image to decipher the player vital signs.

Audio Capture Device (Microphone)

An audio capture device e.g. a microphone can be used to capture vocal expressions of the player and using these audio to decipher the player vital signs.

Thermometer

A sensor used to measure the temperature. In this case to measure the skin temperature of the player engaged in the gameplay.

Heart Rate Monitor

A sensor used to measure the heart rate of a person (player).

Digital Compass

An electro-magnetic device that detects the magnitude and direction of the earth's magnetic field and point to the earth's magnetic north. Used to determine initial state (players facing each other), and then to determine ground-plane orientation during play.

Accelerometer

Used for corroborating the compass when possible, and for determining the up-down plane orientation during play. In an AR game compass and accelerometer provide directionality.

Gyroscope

A gyroscope is a device for measuring or maintaining orientation, based on the principles of conservation of angular momentum. Gyroscopes can be mechanical or based on other operating principles, such as the electronic, microchip-packaged MEMS gyroscope devices found in consumer electronic devices. Gyroscopes include navigation when magnetic compasses do not work, or for the stabilization, or to maintain direction.

Other sensors may be used as needed in particular embodiments of the invention. These sensors may be either embedded in the device where the player is engaging in the gameplay of the virtual world or may be external and attached to different parts of the player's body, or a combination thereof.

The gameplay of the virtual world is impacted based on player's vital signs 104. Several exemplary methods of storyline change based on player vital signs are provided in this application.

The computer program may comprise: a computer usable medium having computer usable program code, the computer usable program code comprises: computer usable program code for presenting graphically to the player the different options available to engage in gameplay via the touchscreen interface.

As mentioned earlier, the term “engage in gameplay” generally implies playing a game whether it is for the purpose of competing, beating, or engaging with other players. It also means to enter a virtual world in order to conduct business, tour a virtual world, or simply interact with others or a virtual environment, with or without competing against another entity.

Several implementation possibilities exist. Some obvious ones are listed below, but there may be other methods obvious to the ones skilled in the art, and the intent is to cover all such scenarios. The application is not limited to the cited examples, but the intent is to cover all such areas that may be used in a virtual world or other applications.

A definable threshold may be useful to define in order to differentiate between intended vital signs caused by the player from those that may be considered normal for the age, sex, weight, height of the player. Thresholds may also be dependent on the operating context. Operating context refers to internal and/or external factors impacting a particular system, device, application, business, organization etc. For example, operating context for an application is the external environment that influences its operation. For a mobile application, the operating context may be defined by the hardware and software environment in the device, the target user, and other constraints imposed by various other stakeholders.

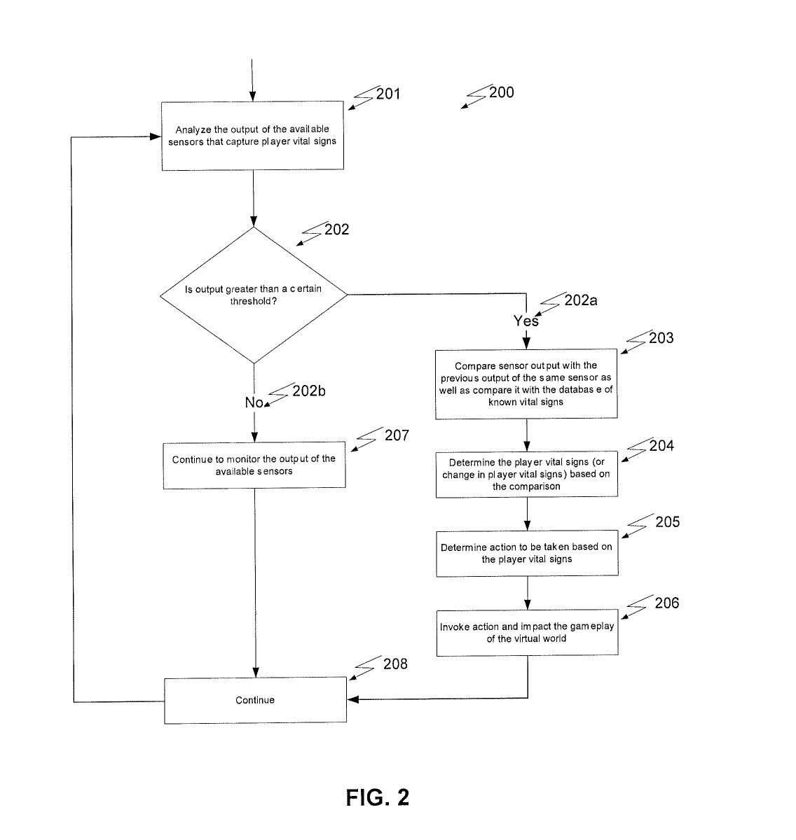

Turning to FIG. 2, a flow diagram is provided representing an example of sensor detection of player vital signs.

In one embodiment of the invention, the output of the available sensors (e.g. thermometer, microphone, pulse monitor etc.) is analyzed 201 to determine whether the output of the sensor is greater than a certain threshold 202, or if the output of the sensor is less than the threshold 202b. If less, then monitoring of the sensor output continues 208.

If the output of the sensor is greater than the threshold 202a, then the system compares the sensor output with the previous output of the same sensor, as well as, with a database of known/normal/baseline vital signs 203. The database may have different thresholds stored in it for comparison. e.g. the normal heart rates for different age groups, skin or body temperature, perspiration on the palms, etc. The database of vital signs may be pre-populated and may also be updated based on the individual player. In one embodiment, this database may be edited/augmented by player(s); in so doing, a player may choose from a list of ranges. The player may record ranges for one or more of the vital signs of themselves when editing/augmenting this database to personalize it.

In one embodiment, this database may be online and the game(s) may access it as needed to compare with currently-detected player vital signs. In another embodiment, this database may be embedded in the game itself wherein the player vital signs are locally deciphered.

In one embodiment, an application analyzes video clips recorded while the player's fingertip is pressed against the lens of the phone's camera. As the camera's light penetrates the skin, it reflects off of pulsing blood in the player's finger. The application is able to correlate subtle shifts in the color of the reflected light with changes in the player's vital signs. Thus such an application (that can be installed on a Smartphone) can measure not only heart rate, but also heart rhythm, respiration rate and blood oxygen saturation using the device's built-in video camera.

In one embodiment, wireless enabled medical monitoring devices may be connected to a Smartphone or other gaming device to keep track of various physiological parameters, such as body temperature, blood pressure, heart rate, heart rhythm, respiration rate and blood oxygen saturation.

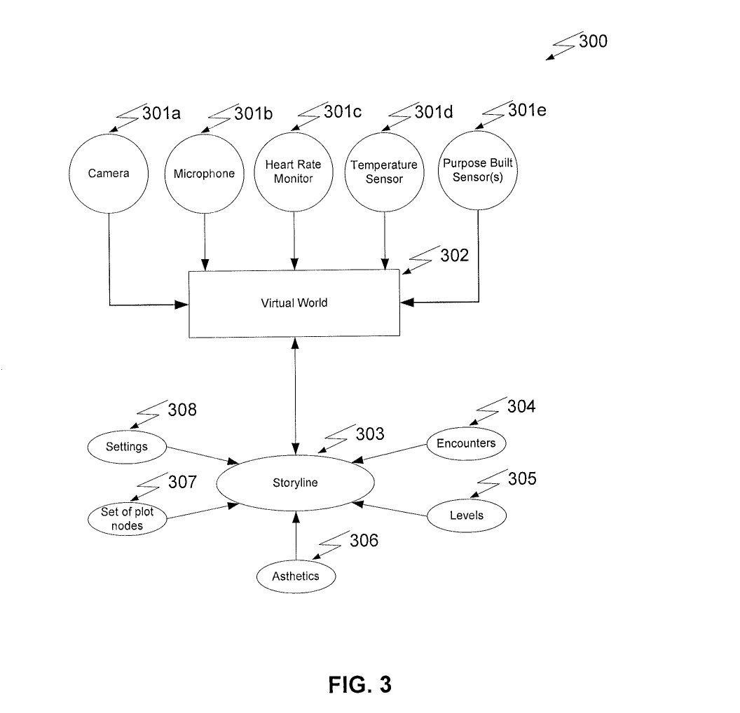

FIG. 3 shows a conceptual view 300 where the various sensors e.g. camera, 301a, microphone 301b, heart rate monitor 301c, temperature sensor 301d and other purpose built sensors (e.g. sensor to measure the body odour of a player) 301e are used for gathering the input from the player to determine the player vital signs.

The storyline 303 may be impacted/changed by a change in any one of the for example encounters 304, levels 305, aesthetics 306, set of plot nodes 307 and/or settings 308 based on the vital signs of the player(s) engaged in the gameplay. The storyline 303 then in turn impacts the gameplay of the virtual world 302.

For the purpose of this application the term “story” may mean storyline, plot nodes, virtual character(s), set of virtual characters or character interaction, encounters, settings, aesthetics, levels, premise or theme amongst other things. The intent is to cover all such areas that may be impacted by the vital signs of the player, and are known to the ones skilled in the art. Some of these terms are explained in more detail below.

Plot

A plot defines the events a story comprises, particularly as they relate to one another in a pattern, a sequence, through cause and effect, or by coincidence. A well thought through plot with many different patterns of events results in a more engaging and interesting game. A plot may have a beginning, a middle, and an end, and the events of the plot may causally relate to one another as being either dependant or probable. A plot may also refer to the storyline or the way a game progresses. Similarly a storyline may refer to a plot or a subplot of a virtual world. Thus for the purpose of this application the terms plot and storyline may be used interchangeably.

Plot Node

In a virtual world a plot node may be defined as a forking point in the storyline where the plot of the story can diverge based on the decisions a player makes, or the vital signs of the player.

Plotline—Set of Plot Nodes

Plotline can be considered a certain sequence of interconnected plot nodes, while a set of plot nodes may or may not be interconnected. A plotline may be integral to the main storyline or may be complimentary and thus provide extra possibilities in terms of virtual character interaction and emotion-specific scenarios. Thus there may be a certain association between a certain player vital signs and a plotline or a certain set of plot nodes. Therefore when a certain player vital signs is determined the gameplay, the plotline or set of plot nodes associated with this vital signs may become incorporated into the gameplay.

Encounters

In a virtual world an encounter may be defined as a meeting between two or more virtual characters or may be thought of as a decision point at which a player encounters an opposing element (e.g. an enemy). An encounter may be player initiated (actively engaging in fighting an enemy) or unwanted by the player. A player may opt to avoid an encounter or may actively engage in them to move to the next level of the virtual world. The outcome of the encounters may at times define how the rest of the game progresses.

A random encounter is a feature commonly used in various role-playing games (RPGs) whereby an encounter with a non-player character (NPC), an enemy, a monster, or a dangerous situation occurs sporadically and at random. Random encounters are generally used to simulate the challenges associated with being in a hazardous environment, such as a monster-infested wilderness or dungeon usually with an uncertain frequency of occurrence to simulate a chaotic nature.

Premise

The premise of a game or concept statement is a short, direct description of the situation of a game and describes the fundamental concept that drives the plot. The premise determines the primary goals of the virtual characters of a virtual world, the opposition to these goals and typically may define the means and the path that these virtual characters may take in achieving those goals. The primary objective is usually sought by both the protagonist (hero) and the antagonist (villain) but may only be achieved by one of them.

Theme

A theme is the main idea, moral, or message, of a game. It is typically the common thread or oft repeated idea that is incorporated throughout a game. Examples of themes in games: espionage-themed role-playing game, martial arts-themed iPod based game, single-player horror-themed PC adventure game, fantasy-themed role-playing game, science fiction themed computer game, adult-themed video game, a horror-themed FPS (first person shooter) video game, futuristic-themed competitive fighting game, paranormal investigation-themed role-playing game etc.

Settings

Settings in the virtual world control multiple areas of the virtual world (game). Settings may be changed by a player or may be impacted by the vital signs of a player.

Levels

A level in the virtual world (video game) terminology refers to a discrete subdivision of the virtual world. Typically a players begins at the lowest level (level 1), and proceeds through increasingly numbered levels, usually of increasing difficulty, until they reach the top level to finish the game. In some games levels may refer to specific areas of a larger virtual world, while in other games it may refer to interconnected levels, representing different locations within the virtual world.

Thus in essence, the storyline may be changed by changing the plot nodes or set of plot nodes, virtual character (both player characters and non-player characters), set of virtual characters or virtual character interaction, settings, aesthetics, levels, premise or theme, encounters, levels etc. Thus a change in player vital signs may impact any one of the earlier mentioned items. The application is not limited to the cited examples, but the intent is to cover all such areas that may be used in a virtual world to impact the storyline of a virtual world.

Several exemplary embodiments/implementations of the invention of a changing storyline based on player vital signs are given below. There may be other methods obvious to the ones skilled in the art, and the intent is to cover all such scenarios.

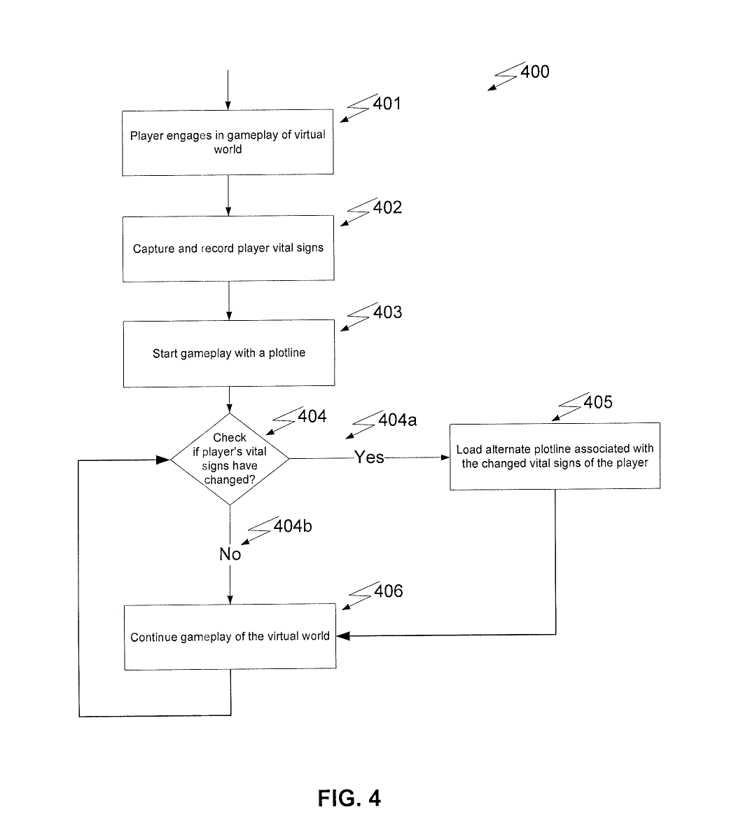

FIG. 4 is a flow diagram representing an example of ongoing vital sign detection.

As the player engages in gameplay of the virtual world 401, the system captures and records the player's vital signs 402. The gameplay starts with a plotline 403. The system checks to see if the player's vital signs have changed 404. If No 404b (the player's vital signs have not changed), then the system continues the gameplay of the virtual world 406. If Yes 404a (the player's vital signs have changed), then the system loads an alternate plot associated with the current vital signs of the player 405 and continues the gameplay of the virtual world 406.

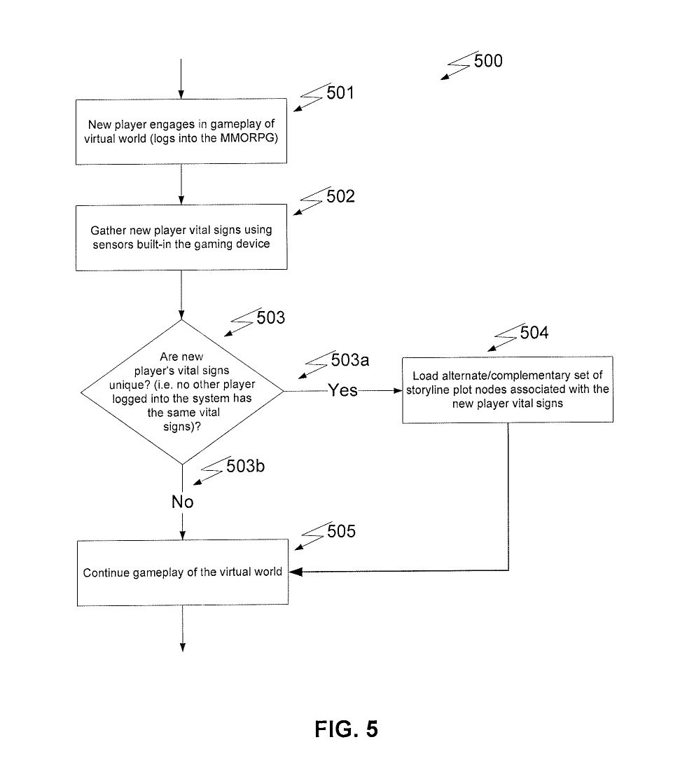

FIG. 5 shows a flow diagram representing an example of how vital signs may be used in a MMORPG context to open certain plot nodes.

A new player engages in gameplay of virtual world for example logs into the MMORPG 501. An MMORPG (Massively Multiplayer Online Role Playing Game) is a genre of role playing games where a very large number of players interact and engage in the gameplay of a virtual world. Such games include several common features for example a persistent game environment, some form of progression, social interaction within the game, in-game culture, membership in a group, and some level of virtual character customization to meet a player's need for a unique virtual character that suits their gaming style.

An alternate embodiment of the invention may be implemented in a console based multiplayer game.

The system gathers new player vital signs using sensors built-in the gaming device 502. The system checks to see if the new player's vital signs are unique 503. The uniqueness of the vital signs of the new player can be determined by comparing it with the vital signs of the other players who are engaged in the game at that time. If No 503b (the player's vital signs are not unique), then the system continues the gameplay of the virtual world 505. If Yes 503a (the new player's vital signs are unique and different from all other players engaged in the gameplay at that time), then the system loads an alternate/complementary set of storyline plot nodes associated with new player vital signs 504 and continues the gameplay of the virtual world 505.

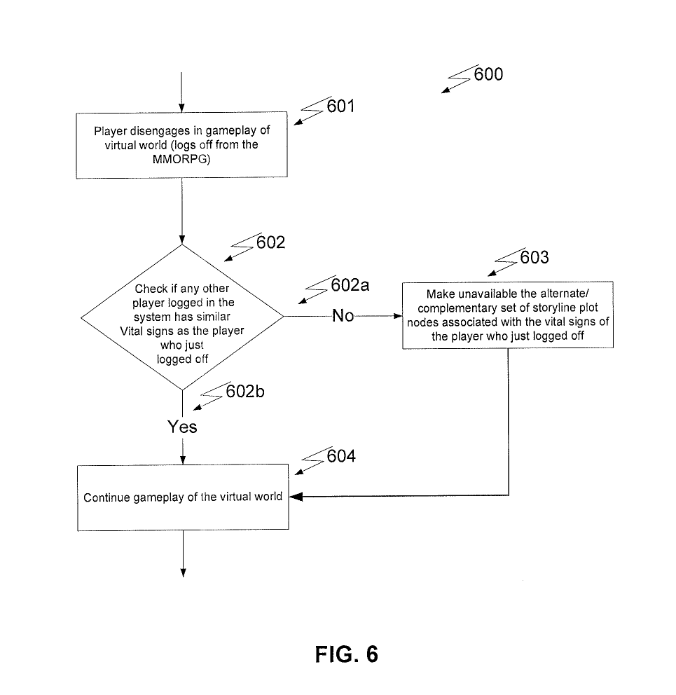

FIG. 6 shows a flow diagram representing an example of how vital signs may be used in a MMORPG context to close certain plot nodes.

A player disengages in gameplay of virtual world for example logs off from the MMORPG 601.

The system checks to see if any other player engaged in the gameplay (i.e. still logged in the game) has a similar vital signs as the player who just logged off 602. Another embodiment of the invention may be implemented in a console based multiplayer game.

If Yes 602b (there is another player who has the same vital signs as the player who just logged off), then the system continues the gameplay of the virtual world 604.

If No 602a (there is no other player logged in the game who has the same expressions and vital signs as the player who just logged off), then the system makes unavailable the alternate/complementary set of storyline plot nodes associated with the vital signs of the player who just logged off 603 and c gameplay of the virtual world 604 continues without that set of storyline plot nodes.

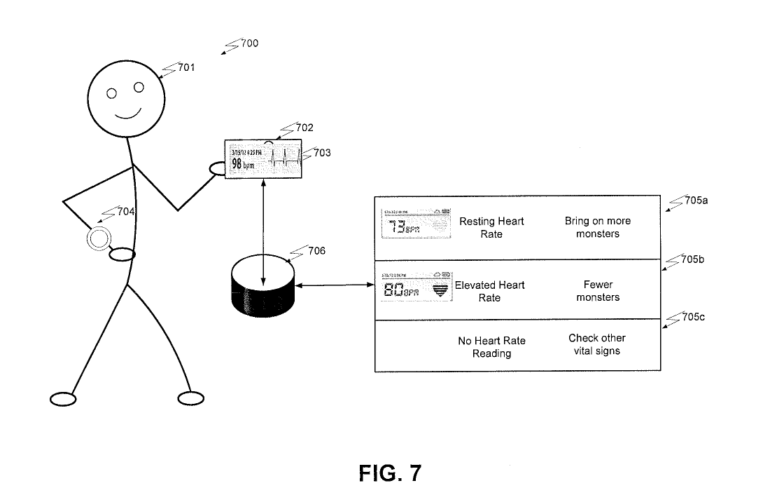

FIG. 7 shows a conceptual diagram of a simple embodiment of the invention, in this case using a mobile device. The mobile device 702 is used for playing the game. A sensor connected to the player and in communication with the mobile device (e.g. by WiFi connection, wired connection, or any other communication protocol) (in this case, heart rate monitor 704) captures the heart rate of the player 700. The detected heart rate is then compared in a database of normal ranges of heart rate given the player's age, sex, etc., and the operating context of the game. The database 706 includes game instructions mapped to each range of detected heart rate 705a-705c. In this case, the “Resting” heart rate that was detected from the sensor is mapped to an instruction for “Bring on more monsters” 705a. The result on the game on the mobile device may also be to show a diagram of the player's heart rate (as shown) 703. If the heart rate had been “Elevated”, the mapping would have retrieved the instruction “Fewer Monsters” 705b. If the expression had been undetectable or neutral, the mapping would have retrieved the instruction “Check other vital signs” 705c. The camera (or video camera) on the device 702 may also be used to detect the player's facial expression 701 as a complementary (or cross-checking) reading with the heart rate.

In one embodiment of the invention the virtual character reflects the vital signs of the player. Thus if the player is exhibiting high body temperature the virtual character may shed some of his heavy winter clothing as he goes about his adventures in the virtual world.

In one embodiment of the invention the virtual character, employing dramatic irony, does the opposite of what the player vital signs. Dramatic irony is when the words and actions of the characters of a work of literature have a different meaning for the reader than they do for the characters. This is the result of the reader having a greater knowledge than the characters themselves. Thus the virtual character may act or speak erroneously to heighten the drama.

In one embodiment of the invention the virtual character may employ pathetic fallacy or anthropomorphic fallacy. Pathetic fallacy or anthropomorphic fallacy is the treatment of inanimate objects as if they had human feelings, thought, or sensations. The word ‘pathetic’ in this context is related to ‘pathos’ or ‘empathy’ (capability of feeling). The endowment of nature to inanimate objects with human traits and feelings, as in the smiling skies; the angry sea; the weeping clouds illustrates this.

In one embodiment of the invention the health of the virtual character may also be directly or indirectly impacted by the player's vital signs e.g. in one embodiment of the invention if the player is exhibiting high blood pressure and increase heart rate then the health of the virtual character may deteriorate and if the player is calm with a steady body temperature and even breathing the health of the virtual character may improve.

In one embodiment of the invention, a non-gaming application may also use the system and method disclosed in this application. For example an application for a mobile device like an iPhone or other similar device where a user may be performing some physical action, such as a demonstration or virtual performance where digital media may be intermixed with the presentation. The said mobile device may connect to a backend server using a network e.g. WiFi or wireless network of a service provider etc.

In another embodiment of the invention, the gaming device and the virtual world that may exist on it may incorporate the system and method of the invention. As the above examples illustrate, virtual worlds enabled by the disclosed invention allows for a merging of the physical and virtual worlds. This has implications for how users interact with the virtual world explicitly via controllers and implicitly via vital signs.

One embodiment of the invention may preferably also provide a framework or an API (Application Programming Interface) for virtual world creation that allows a developer to incorporate the functionality of capturing the player vital signs and using this to impact the storyline. Using such a framework or API allows for a more uniform virtual world generation, and eventually allows for more complex and extensive ability to interact with virtual objects.

It should be understood that although the term game has been used as an example in this application but in essence the term may also imply any other piece of software code where the embodiments of the invention are incorporated. The software application can be implemented in a standalone configuration or in combination with other software programs and is not limited to any particular operating system or programming paradigm described here. For the sake of simplicity, we singled out game applications for our examples. Similarly we described users of these applications as players. There is no intent to limit the disclosure to game applications or player applications. The terms players and users are considered synonymous and imply the same meaning. Likewise, virtual worlds, games and applications imply the same meaning. Thus, this application intends to cover all applications and user interactions described above and ones obvious to the ones skilled in the art.

Although interacting with virtual objects has been exemplified above with reference to gaming, it should be noted that virtual objects are also associated with many industries and applications. For example, virtual worlds/objects can be used in movies, cartoons, computer simulations, and video simulations, among others. All of these industries and applications would benefit from the disclosed invention.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to those familiar with the art.

1. A computer-implemented method of enabling virtual gameplay with a virtual character on a computing device in communication with a storage means, the method comprising the steps of:
providing access to at least one video game in which a player is able to interact with the video game via a virtual character;
detecting at the computing device at least one vital sign of the player, and storing the at least one vital sign on the storage means; and
in response to the detected at least one vital sign, retrieving using the computing device a storyline for the virtual character to interact with, the retrieved storyline being related to the at least one vital sign of the player.

2. The method of claim 1, further comprising detecting a second or subsequent vital sign of the player in the course of gameplay, and retrieving a second or further storyline for the player's virtual character to interact with, the second or further storyline being related to the second or subsequent vital sign.

3. The method of claim 1, wherein each storyline comprises one or a combination of plot, plot nodes, character interactions, encounters, settings, aesthetics, levels, premise, or theme.

4. The method of claim 2, wherein the second or further storyline replaces the previously retrieved storyline.

5. The method of claim 2, wherein the second or further storyline is added to the previously retrieved storyline.

6. The method of claim 1, further comprising modifying the virtual character's appearance, facial or body expression or health in response to the detected at least one vital sign.

7. The method of claim 1, further comprising modifying a level of difficulty in response to the detected at least one vital sign.

8. The method of claim 7, wherein a detected resting or calm vital sign results in an increased level of difficulty.

9. The method of claim 7, wherein a detected agitated or elevated vital sign results in a decreased level of difficulty.

10. The method of claim 7, wherein a relative range of vital sign is considered with respect to an operating context within the game.

11. The method of claim 6, wherein the virtual character is changed to reflect a state matching the player's detected vital sign.

12. The method of claim 6, wherein the virtual character is changed to reflect a state opposite to the player's detected vital sign.

13. The method of claim 1, wherein the scene or setting is modified in response to the player's detected vital sign.

14. The method of claim 1, wherein game monsters, enemies, traps or puzzles are modified in response to the player's detected vital sign.

15. The method of claim 1, further comprising modifying character statistics of the virtual character in response to the detected vital sign.

16. The method of claim 1, further comprising modifying tools, weapons, equipment or clothing of the virtual character in response to the detected vital sign.

17. The method of claim 1, wherein the video game is accessible by multiple players, each player having a detected vital sign, and players within a similar range in their detected vital signs can interact in the game with each other via their virtual characters.

18. The method of claim 17, wherein a new player joining the game having a previously-unrepresented range of vital sign opens up a new storyline for all of the players currently in the game.

19. The method of claim 17, wherein if a player is the only player within a specific range of vital sign, the departure of that player from the game closes up the storyline for the remaining players in the game.

20. The method of claim 1, wherein the at least one vital sign is re-detected at intervals, and in the event of a change in the vital sign, the virtual character is shown moving to a new scene in the storyline.

21. The method of claim 1, wherein the detecting step further includes taking a baseline reading of the player's vital sign before the game and comparing a subsequently detected vital sign to see if it is above or below the baseline.

22. The method of claim 1, wherein the detecting step further includes comparing the player's vital sign to a database of normal ranges for that vital sign, the database being broken down by at least one of: gender, sex, age, height, weight, build, physical condition.

23. The method of claim 22, wherein the database is further broken down having regard to aspects of the game operating context.

24. The method of claim 22, wherein the database can be customized with player input.

25. The method of claim 1, wherein if a null vital sign is detected or the detected vital sign is unsupported, a default storyline is provided.

26. The method of claim 1, wherein the storage means is provided by one or a combination of: a local fixed memory, a local removable memory, a remote fixed memory, a remote removable memory, and a virtual memory.

27. The method of claim 1, wherein the storage means is selected from the group consisting of: a local data storage of a game console, a local inbuilt memory, a user provided memory, an online server, and a shared folder on a network.

28. The method of claim 1, wherein the detecting step includes retrieving vital sign data from a sensor.

29. The method of claim 1, wherein the player is enabled to play the game using a game device, and the player's at least one vital sign is detected by an on-board sensor on the game device.

30. The method of claim 29, wherein the game device is a mobile device.

31. The method of claim 28, wherein the sensor is one or a combination of: camera, video camera, microphone, accelerometer, gyroscope, touch screen, temperature sensor, pressure sensor, heart rate monitor, pulse monitor, respiration monitor, moisture sensor, pH sensor, artificial nose.

32. The method of claim 28, wherein the sensor is a purpose-built sensor.

33. The method of claim 28, wherein the sensor is attached to the player's body during game play.

34. The method of claim 1, wherein the detecting step includes obtaining vital sign information from player input.

35. The method of claim 31, wherein the sensor is a sensor that is not otherwise used as a game controller.

36. The method of claim 31, wherein any sensor used as a game controller is not used to receive player vital signs.

37. The method of claim 29, wherein the onboard sensor is a video camera, and wherein the video camera is used to detect blood flow, blood colour, or blood pressure as a vital sign.
